(19) United States
(12) Patent Application Publication
(10) Pub. No.: US 2023/0013012 A1
(43) Pub. Date: Jan. 19, 2023

(54) REGULATORY COMPLIANCE ANALYSIS PLATFORM

(71) Applicant: BOND QUALITY CONSULTING LLC, Lousville, CO (US)

(72) Inventors: Natasha L. BOND, Louisville, CO (US); Sean WHITSITT, Tucson, AZ (US); Ryan A. MAISH, Tucson, AZ (US); William L. CLIFTON, Houston, TX (US); Amanda SHIH, Houston, TX (US)

(21) Appl. No.: 17/861,000

(22) Filed: Jul. 8, 2022

Related U.S. Application Data
(60) Provisional application No. 63/219,687, filed on Jul. 8, 2021.

(51) Int. Cl. G06Q 30/00

(52) U.S. Cl. CPC G06Q 30/018

(57) ABSTRACT

An example method for generating standard operating procedure documentation includes receiving, by a processor, product information corresponding to a product to be produced by a product manufacturer; analyzing, by the processor, the product information and one or more regulatory requirements for a geographical jurisdiction; generating, by the processor, a template for the standard operating procedure documentation, where the template includes a document element referencing multiple content elements within the template; and generating, by the processor, the standard operating procedure documentation that defines operating procedures for testing, producing, manufacturing, and/or designing the product using the template and the product information.

### CROSS-REFERENCE TO RELATED APPLICATIONS

This application claims the benefit of priority pursuant to 35 U.S.C. § 119(e) of U.S. Provisional Patent Application No. 63/219,687, filed Jul. 8, 2021, titled “Regulatory Compliance Analysis Platform,” which is hereby incorporated by reference herein in its entirety.

### FIELD

The described embodiments relate generally to systems and methods for analyzing requirements for regulatory processes, automating the creation of Standard Operating Procedure (SOP) documentation, and automating guidance for regulatory compliance as all three items relate to regulated medical products.

### BACKGROUND

Medical Product Manufacturers (MPMs) must comply with regulatory requirements created by regulatory authorities such as the Food and Drug Administration (FDA). Compliance is demonstrated through thorough documentation of business and engineering procedures and through thorough documentation of the implementation of those procedures. The documentation of the procedures and the implementation of the procedures are typically manually generated by experienced quality management professionals. Navigating the authorship and the implementation of the procedures is difficult, time consuming, and expensive for inexperienced users. Often, many companies resort to hiring experts, such as lawyers and quality management consultants, that assist with such processes, but these professionals can be expensive and time consuming and result in varying outcomes. Therefore, there is a need for a platform that can efficiently and effectively help manage and make recommendations for such regulations and regulatory authorities.

### SUMMARY

An example method for generating standard operating procedure documentation includes receiving, by a processor, product information corresponding to a product to be produced by a product manufacturer; analyzing, by the processor, the product information and one or more regulatory requirements for a geographical jurisdiction; generating, by the processor, a template for the standard operating procedure documentation, where the template includes a document element referencing multiple content elements within the template; and generating, by the processor, the standard operating procedure documentation that defines operating procedures for testing, producing, manufacturing, and/or designing the product using the template and the product information.

An example regulatory and compliance platform includes a template database comprising a plurality of regulatory compliance templates, where the regulatory compliance templates are specific to a product type, and/or a product jurisdiction. The example platform further includes a processor executing an analysis algorithm in communication with the template database, where the analysis algorithm is configured to receive product information for a product to be produced by a product manufacturer, analyze the product information to select and generate a regulatory compliance template from the plurality of regulatory compliance templates, where the regulatory compliance template includes a document element referencing multiple content elements within the regulatory compliance template, populate, based on the multiple content elements, the regulatory compliance template with information specific to the product and the product manufacturer, and generate one or more of a standard operation procedures content, a deliverable item, an action item, or a guidance content based on the populated regulatory compliance template.

Example non-transitory computer readable media encode instructions which, when executed by one or more processors, cause the one or more processors to receive product information corresponding to a product to be produced by a product manufacturer, analyze the product information and one or more regulatory requirements for a geographical jurisdiction, generate a template for the standard operating procedure documentation, where the template includes a document element referencing multiple content elements within the template, and generate the standard operating procedure documentation that defines operating procedures for testing, producing, manufacturing, and/or designing the product using the template and the product information.

Additional embodiments and features are set forth in part in the description that follows, and will become apparent to those skilled in the art upon examination of the specification and may be learned by the practice of the disclosed subject matter. A further understanding of the nature and advantages of the present disclosure may be realized by reference to the remaining portions of the specification and the drawings, which form a part of the disclosure. One of skill in the art will understand that each of the various aspects and features of the disclosure may advantageously be used separately in some instances, or in combination with other aspects and features of the disclosure in other instances.

### BRIEF DESCRIPTION OF THE DRAWINGS

The description will be more fully understood with reference to the following figures in which components are not drawn to scale, which are presented as various examples of the present disclosure and should not be construed as a complete recitation of the scope of the disclosure, characterized in that:

FIG. 1 illustrates an example system including a regulatory compliance analysis platform in accordance with various embodiments of the disclosure.

FIG. 2 is a schematic diagram of an example computer system implementing various embodiments in the examples described herein.

FIG. 3A illustrates a block diagram for generating recommendations and guidance for regulatory approval processes using the regulatory compliance analysis platform, in accordance with embodiments described herein.

FIG. 3B illustrates an example of generating customized content using a template and questionnaire converted into customized content, in accordance with embodiments described herein.

FIG. 3C illustrates a second example of generating customized content using a template and questionnaire converted into customized content, in accordance with embodiments described herein.

FIG. 3D illustrates a third example of generating customized content using a template and questionnaire converted into customized content, in accordance with embodiments described herein.

FIG. 4 illustrates an example block diagram for maintaining and updating content templates for use in generating customized content, in accordance with embodiments described herein.

FIG. 5A illustrates an example block diagram for utilizing output from the content database for both document generation and for delivering documents and customized content to end users, in accordance with embodiments described herein.

FIG. 5B illustrates an example of document generation from a content database, in accordance with embodiments described herein.

FIG. 5C illustrates an example of document and action list generation utilizing survey results and templates in accordance with embodiments described herein.

FIG. 6A shows the structure of the data model which is used to store the content and templates in accordance with embodiments described herein.

FIG. 6B shows an example of content stored as a model in accordance with embodiments described herein.

FIG. 6C shows an example of a template stored as a model in accordance with embodiments described herein.

FIG. 7 illustrates a process for generating SOP documentation in accordance with embodiments described herein.

FIG. 8 illustrates an example user interface for displaying a questionnaire used in generating SOP documentation in accordance with embodiments described herein.

### DETAILED DESCRIPTION

The systems and methods described here relate to analyzing regulatory requirements, automating creation of quality SOP documentation, and automating guidance for regulatory compliance (including generation of guidance documentation). In some examples, the system may receive user, company, and/or product information, such as input via a questionnaire or survey, and analyze the provided input to determine applicable regulatory requirements for a particular product. The system may navigate through one or more surveys or questionnaires based on received product information, e.g., any particular question response may be used to determine additional questions to present to the user to receive additional input. In this manner, the system may be configured to retrieve sufficient information to analyze regulatory requirements.

In addition to analyzing regulatory requirements, the system may assist in creating documentation that may be useful in determining compliance with regulatory requirements and/or documentation that may be used to help ensure compliance with regulatory approval. For example, the system may receive information regarding the particular product and based on an analysis of the regulatory requirements, may generate a set of forms to be completed by the user (or other users associated with the product or MPMs). For example, the system may generate SOP documentation that can be used to define and document a company's procedures and standards in generating, testing, and/or finalizing a particular product. The SOP documentation may be generated based on an analysis of the type of product, production information, use information, and/or regulatory requirements.

In some embodiments, the system may dynamically update the algorithms and assessment information based on changes in regulatory requirements. For example, as new regulatory provisions become enforceable, the system may update to generate SOP documentation and/or analysis to reflect the changes in the requirements.

In various embodiments, the system may utilize templates based on regulatory requirements. The system may then use user provided information to select a particular template, e.g., via a best fit assessment. Based on the selected template, the system may determine and/or generate SOP templates that can be completed or customized to the particular product or user for the MPM. Alternatively or additionally, the system may generate guidance documentation that may include instructions or information that can be used by the MPM in outlining procedures for testing, production, and the like. Further, based on selected SOP templates and documentation, the system may generate deliverable requirements, actions, activities, and/or deadlines. The various deliverables and/or activities may be selected to help ensure compliance with regulatory requirements, as well as document such compliance.

In various examples, templates may be stored in several locations, and may be generated when documentation is requested. For example, a template may be stored as a document with references to individual content elements. The content items may be separately stored and may, in some examples, include references to additional content items, action items, and guidance. Accordingly, content items may be referenced by multiple document elements, reducing duplication of data which may occur when storing fully formed templates. Additionally, because content items may store references to action items or other guidance, other meaningful documentation allowing companies to fully utilize SOP documents and remain in compliance with various regulations may be generated with SOP documentation. Such guidance and action item lists may be dynamically generated according to specifics of the products, making it easier for companies to comply with various regulations and decreasing unnecessary work by companies in attempting to comply with various medical device regulations.

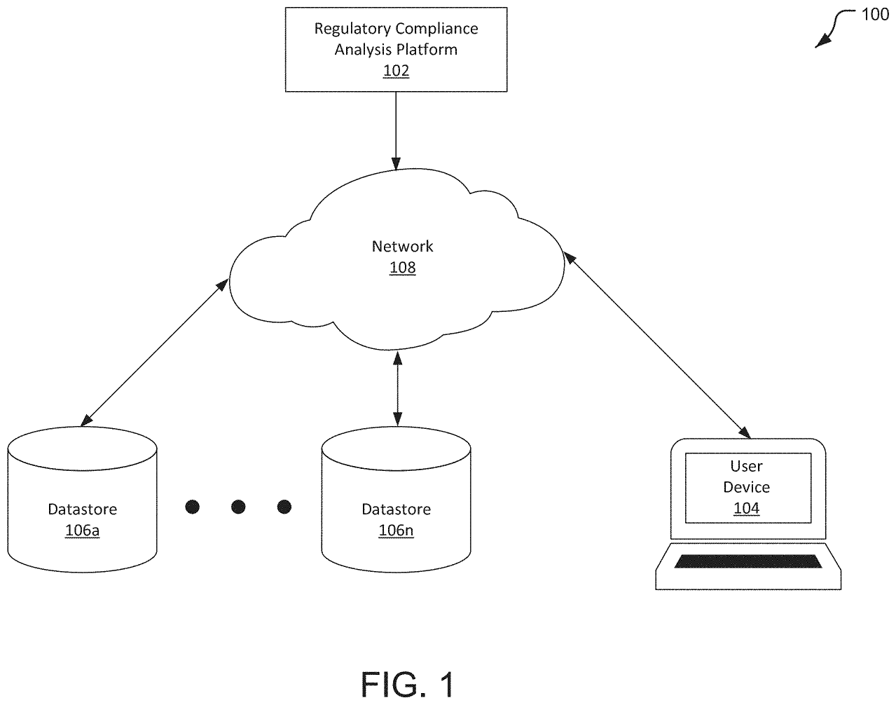

Turning now to the drawings, FIG. 1 illustrates an example system including a regulatory compliance analysis platform 102 in accordance with various embodiments of the disclosure. The regulatory compliance analysis platform 102 may generally communicate with various systems and devices, such as user device 104 and various data sources, such as datastores 106a-106n to generate various deliverables and/or activities to help ensure compliance with regulatory requirements based on user input. The regulatory compliance analysis platform 102, the user device 104, and datastores 106a-106n may communicate with one another through a network 108. The components of the system 100 described herein are exemplary and, in various examples, the system 100 may include fewer or more components. For example, multiple user devices may access the regulatory compliance analysis platform 102 via the network 108.

The regulatory compliance analysis system 102 may be generally implemented by a computing device or combinations of computing resources in various embodiments. In various examples, the regulatory compliance analysis system 102 may be implemented by one or more servers, cloud computing resources, and/or other computing devices. The regulatory compliance analysis system 102 may, for example, utilize various processing resources to generate user interfaces and interact with user devices, retrieve, create, and/or update templates, and generate custom documentation. For example, the regulatory compliance analysis system 102 may utilize or include one or more processors, such as a central processing unit (CPU), graphics processing unit (GPU), and/or programmable or configurable logic.

In some embodiments, various components of the regulatory compliance analysis system 102 may be distributed across various computing resources, such that the components of the regulatory compliance analysis system 102 communicate with one another through the network 108 or using other communications protocols. For example, in some embodiments, the regulatory compliance analysis system 102 may be implemented as a serverless service, where computing resources for various components of the regulatory compliance analysis system 102 may be located across various computing environments (e.g., cloud platforms) and may be reallocated dynamically and/or automatically according to, for example, resource usage of the regulatory compliance analysis system 102. In various implementations, the regulatory compliance analysis system 102 may be implemented using organizational processing constructs such as functions implemented by worker elements allocated with compute resources, containers, virtual machines, and the like.

The regulatory compliance analysis system 102 may further include memory and/or storage locations to store program instructions for execution by the processor and various data utilized by the regulatory compliance analysis system 102. Memory, including, in some examples, datastores 106a-106n, may further store data and/or instructions for retrieving data used by the regulatory compliance analysis system 102. Similar to the processing resources, memory resources utilized by the regulatory compliance analysis system 102 may be distributed across various physical computing devices.

In various examples, memory, including, in some examples, datastores 106a-106n, may store various information utilized by the regulatory compliance analysis system 102, such as, for example, templates, product data, content, and regulatory requirements. In various examples, memory utilized by the regulatory compliance analysis system 102 may further include generating and/or receiving information from one or more user interfaces presented, for example, at a user device 104. Memory may further store various product data, including, for example, survey information about products, companies manufacturing products, information about products and/or companies retrieved from public and/or private databases, and the like.

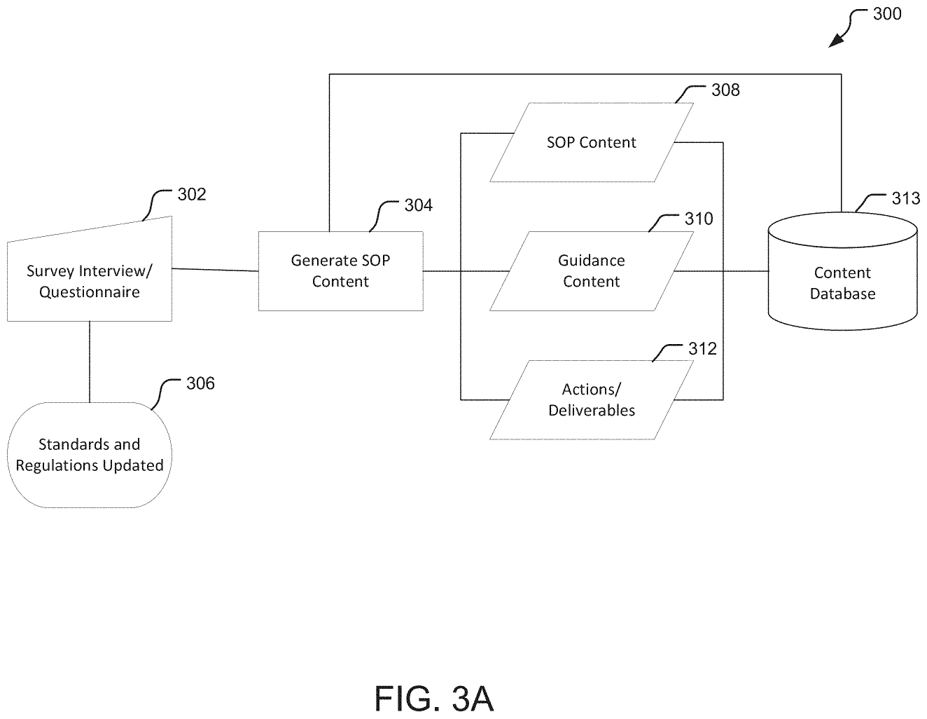

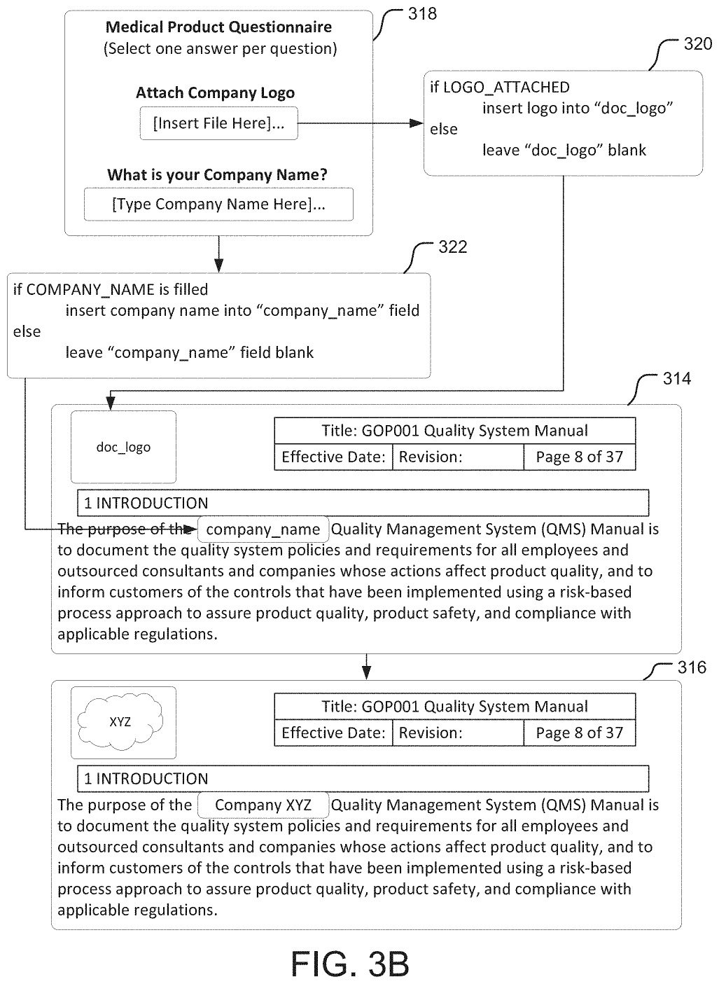

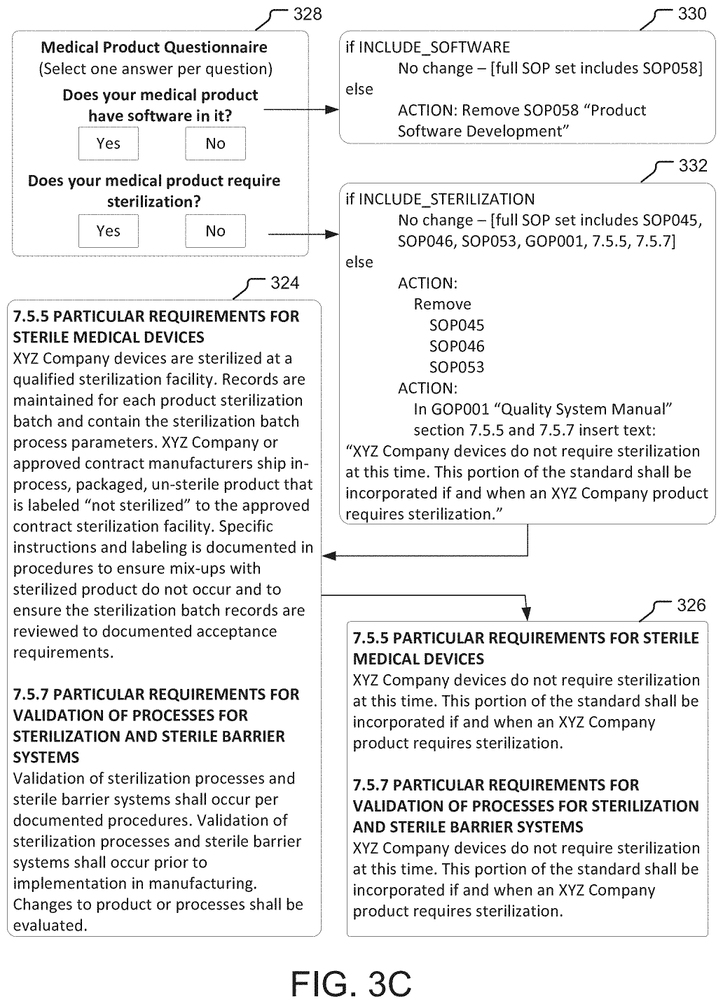

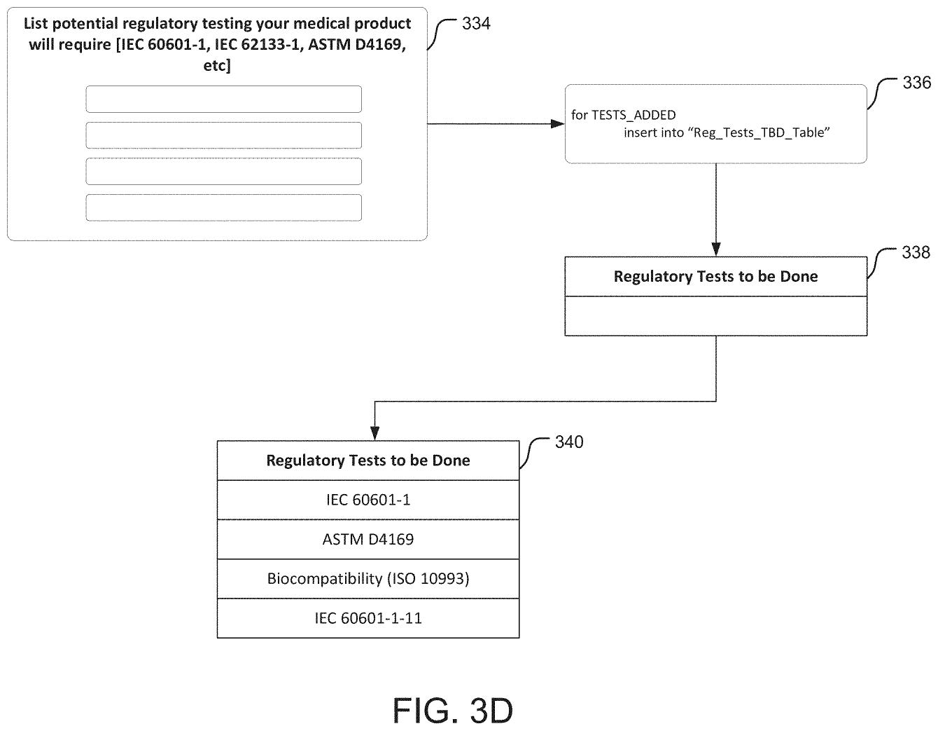

In various examples, templates may contain software code which, when processed, causes the regulatory compliance analysis system 102 to generate a customized document from the template. For example, templates can contain software code which can be processed to refine the template into a customized document. This code is referred to herein as a control. Generally, a control may contain any software code. More specifically, the code within the template is meant to process input data (e.g., answers provided by a user to a questionnaire) to refine the template. FIG. 3B, FIG. 3C, and FIG. 3D describe basic functions of the software code that can be embedded within a template. Generally, this code can, for example, replace placeholder information with specific information, provide conditional statements to select between multiple variations of text, and/or iterate over lists of information to provide similar output for each item in the list. Any of the above general functions can be combined or nested together to create more advanced functionality. For instance, the system may iterate over conditional statements.

Content may generally be documentation, guidelines, and/or other information generated by the regulatory compliance analysis system 102. Content stored at the datastores 106a-106n may include, for example, full documents, subcomponents of documents, formatting for documents, text for inclusion in a document, software instructions, figures, tables, subcomponents of tables, and the like. Content may include document elements referencing content elements to be included in a document. Content elements stored at the datastores may further include references to other content elements, guidance or action items, and the like. Content may include content contained in an SOP for a quality management system and/or forms and attachments for an SOP, guidance documentation meant to provide instructions on how to use and/or implement SOPs, and/or information on actionable tasks and deliverables that are required for regulatory compliance.

Generally, the user device 104 (and other user devices accessing the regulatory compliance analysis system 102) may be implemented using any number of computing devices including, but not limited to, a computer, a laptop, tablet, mobile phone, smart phone, wearable device (e.g., AR/VR headset, smart watch, smart glasses, or the like), smart speaker, vehicle (e.g., automobile), or appliance. Generally, the user devices may include one or more processors, such as a CPU and/or GPU. The user devices may generally perform operations by executing executable instructions (e.g., software) using the processor(s).

In various examples, the user device 104 may include a display or other user interface which may be used to interact with (e.g., receive information from and send information to) the regulatory compliance analysis system 102. For example, the regulatory compliance analysis system 102 may generate a user interface for display at the user device 104 to collect information about a medical device, company, and the like, from the user device 104 for use by the regulatory compliance analysis system 102 in generating customized documentation for regulatory compliance. Customized documentation, instructions, and other information generated by the regulatory compliance analysis system 102 may further be transmitted to and/or displayed by the user device 104.

The network 108 may be implemented using one or more of various systems and protocols for communications between computing devices. In various embodiments, the network 108 or various portions of the network 108 may be implemented using the Internet, a local area network (LAN), a wide area network (WAN), and/or other networks. In addition to traditional data networking protocols, in some embodiments, data may be communicated according to protocols and/or standards including near field communication (NFC), Bluetooth, cellular connections, and the like.

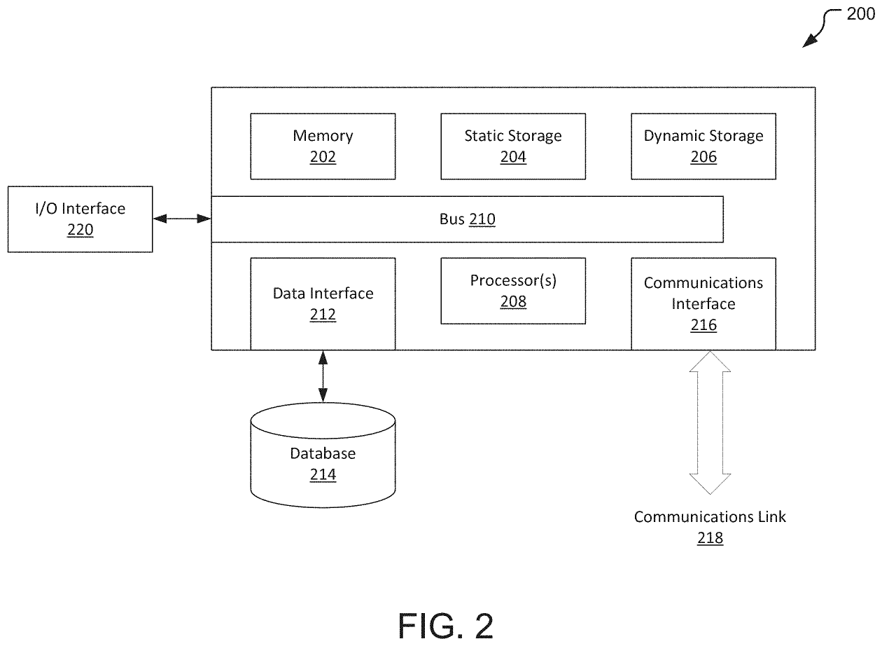

The regulatory compliance analysis system 102 may be implemented using various computing systems. Turning to FIG. 2, an example computing system 200 may be used for implementing various examples in the examples described herein. For example, the regulatory compliance analysis system 102 may include or utilize one or several computing systems 200. In various embodiments, one or more user devices 104 may also be implemented by a computing system 200. This disclosure contemplates any suitable number of computing systems 200. For example, the computing system 200 may be a server, a desktop computing system, a mainframe, a mesh of computing systems, a laptop or notebook computing system, a tablet computing system, an embedded computing system, a system-on-chip, a single-board computing system, or a combination of two or more of these. Where appropriate, the computing system 200 may include one or more computing systems; be unitary or distributed; span multiple data centers; or reside in a cloud, which may include one or more cloud components in one or more networks.

Computing system 200 includes a bus 210 (e.g., an address bus and a data bus) or other communication mechanism for communicating information, which interconnects subsystems and devices, such as processor 208, memory 202 (e.g., RAM), static storage 204 (e.g., ROM), dynamic storage 206 (e.g., magnetic or optical), communications interface 216 (e.g., modem, Ethernet card, a network interface controller (NIC) or network adapter for communicating with an Ethernet or other wire-based network, a wireless NIC (WNIC) or wireless adapter for communicating with a wireless network, such as a WI-FI network), input/output (I/O) interface 220 (e.g., keyboard, keypad, mouse, microphone). In particular embodiments, the computing system 200 may include one or more of any such components.

In particular embodiments, processor 208 includes hardware for executing instructions, such as those making up a computer program. The processor 208 circuitry includes circuitry for performing various processing functions, such as executing specific software for perform specific calculations or tasks. In particular embodiments, I/O interface 220 includes hardware, software, or both, providing one or more interfaces for communication between computing system 200 and one or more I/O devices. Computing system 200 may include one or more of these I/O devices, where appropriate. One or more of these I/O devices may enable communication between a person and computing system 200.

In particular embodiments, communications interface 216 includes hardware, software, or both providing one or more interfaces for communication (such as, for example, packet-based communication) between computing system 200 and one or more other computer systems or one or more networks. One or more memory buses (which may each include an address bus and a data bus) may couple processor 208 to memory 202. Bus 210 may include one or more memory buses, as described below. In particular embodiments, one or more memory management units (MMUs) reside between processor 208 and memory 202 and facilitate accesses to memory 202 requested by processor 208. In particular embodiments, bus 210 includes hardware, software, or both coupling components of computing system 200 to each other.

According to particular embodiments, computing system 200 performs specific operations by processor 208 executing one or more sequences of one or more instructions contained in memory 202. For example, instructions for various functions of the regulatory compliance analysis system 102 may be contained in memory 202 and may be executed by the processor 208. Such instructions may be read into memory 202 from another computer readable/usable medium, such as static storage 204 or dynamic storage 206. In alternative embodiments, hard-wired circuitry may be used in place of or in combination with software instructions. Thus, particular embodiments are not limited to any specific combination of hardware circuitry and/or software. In various embodiments, the term “logic” means any combination of software or hardware that is used to implement all or part of particular embodiments disclosed herein.

The term “computer readable medium” or “computer usable medium” as used herein refers to any medium that participates in providing instructions to processor 208 for execution. Such a medium may take many forms, including but not limited to, nonvolatile media and volatile media. Non-volatile media includes, for example, optical or magnetic disks, such as static storage 204 or dynamic storage 206. Volatile media includes dynamic memory, such as memory 202.

Computing system 200 may transmit and receive messages, data, and instructions, including program, e.g., application code, through communications link 218 and communications interface 216. Received program code may be executed by processor 208 as it is received, and/or stored in static storage 204 or dynamic storage 206, or other storage for later execution. A database 214 may be used to store data accessible by the computing system 200 by way of data interface 212. For example, various data utilized by the regulatory compliance analysis platform 102 may each be stored using a database 214. In various examples, communications link 218 may communicate with, for example, user devices (e.g., user device 104) to display user interfaces to the regulatory compliance analysis platform 102.

FIG. 3A illustrates a block diagram for generating recommendations and guidance for regulatory approval processes using the regulatory compliance analysis platform 102. In some embodiments, content is ingested into the system 100 via a survey/questionnaire (or other input mechanism) and fed into an automated generation process that uses templates to generate content that is then stored in a content database or repository. Results and/or answers from a survey 302 may be provided to the regulatory compliance analysis platform 102 to complete generation of SOP content 304. The survey 302 may be a manually conducted survey or a form-filled survey using a website or other means of automated collection, e.g., user information, such as product information and/or manufacturer information may be received by the system, such as via a user interface at the user device 104. In some examples, the survey 302 may be presented through a web portal at the user device 104. The results from the survey may be converted to a digital format which can be read by an automated process. Conversion may be completed by the user entering information to the digital form directly (e.g., by a user entering information into a web-based form at the user device 104).

In various examples, specific questions presented through the survey 302 may be updated based on updated standards and regulations 306. For example, where regulations and/or standards are updated to require additional verbiage in an SOP for a sub-category of products, the survey 302 may be updated to collect information regarding whether the product belongs in the sub-category. In various examples, the regulatory compliance analysis system 102 may scrape various data sources (e.g., public databases containing regulations) to obtain up-to-date regulations and to determine when a regulation or standard is updated in a manner which requires an update to the survey 302.

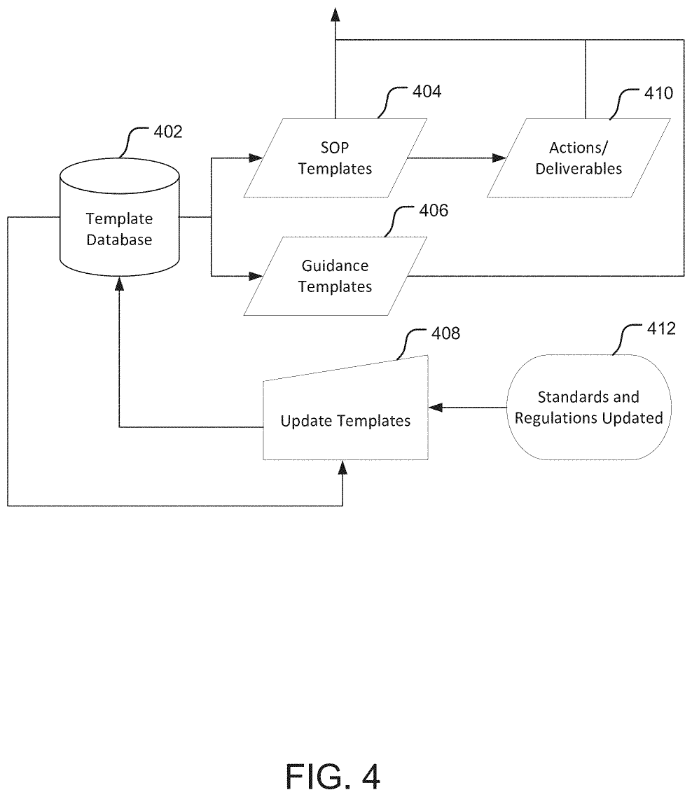

Generation of SOP content 304 may be an automated process utilizing survey responses or other product information (e.g., information input by a user) to complete template documents. The template documents may be selected as discussed herein, for example, with respect to FIG. 4. Broadly, templates applicable to a particular product may be chosen based on survey responses and/or other information about a product (e.g., information stored by the regulatory compliance analysis system 102 during previous generation of documentation). In some examples, the generation of SOP content 304 and/or selection of templates may further be based on other sources of information about a product and/or a company producing the product. For example, the regulatory compliance analysis system 102 may utilize information about a company provided with respect to another product to generate SOP content 304. In some examples, such information may be stored at content database 312. In some examples, products may be developed over several phases and previously created content for the product may be used to select templates and/or otherwise generate SOP content 304. Such previously created content may likewise be stored at the content database 312. The regulatory compliance analysis system 102 may, in some examples, obtain further information from other sources, such as publicly and/or privately available databases, public filings, company websites, and the like.

The information provided in response to the survey 302 may be analyzed and used to select a template or multiple templates to select for generation of SOP content 304. Generally, the entire template archive may searched and/or processed, but certain templates may be excluded if the survey information indicates that they are unneeded in the customized set of content output from the process (e.g., if a medical product does not include software, the template documents specific to software may be excluded).

The various types of content generated by the regulatory compliance analysis platform 102 may include SOP content 308, guidance content 310, and/or actions and deliverables 312. SOP content 308 may include content contained in an SOP for a quality management system or forms and attachments for an SOP. Guidance content 310 may include documentation meant to provide instructions on how to use and/or implement SOPs. Actions and deliverables 312 may include information on actionable tasks and deliverables that are required to be completed for regulatory compliance. The generated content, including SOP content 308, guidance content 310, and/or actions and deliverables 312 may be stored in the content database 313 or repository from which data can be queried manually or automatically. In various examples, the generated content may further be provided to a user through, for example, a user interface at the user device 104.

SOP content 308 may include any document necessary for inclusion in a functional Quality Management System (QMS), including forms and other accompanying or attachment documents used by the processes described in the SOPs. SOP content 308 may also include other documents which are required by a functional QMS such as, for example, Global Operating Procedures (GOP). Examples of SOPs and types of SOPs may be, for example, “SOP001 Management Review” which defines a process by which upper management must review quality processes, “SOP003 Design Control” which defines the requirements and functional responsibilities for developing new or modifying medical products, “SOP007 Supplier Controls” which defines requirements, responsibilities, and approvals required for services and goods acquired by a company, “SOP015 Training” which defines activities necessary to ensure that personnel can proficiently perform their assigned responsibilities, “SOP014 Record Retention” which defines the requirements and responsibilities of a company for retaining quality system records, and “GOP002 Global Glossary” which provides definitions for all terms used within the SOP documentation. Non-limiting examples of forms and accompanying or attachment documents required by SOPs include “SOP003 A Form, Design Traceability Matrix” which is used to trace together design components, “SOP007 B Form, Approved Supplier List” which is used to track the suppliers which have undergone the process defined by “SOP007 Supplier Controls,” and “SOP012 A Form, Equipment Identification Number Log” in which equipment owned and operated by a company is recorded.

Guidance content 310 may include any documents, videos, images, or other media created to describe a process, procedure, function, term, or other necessary information for performing the regulated duties of a MPM. Guidance content may include, for example, step-by-step guides, task descriptions, process descriptions, flowcharts, how-to guides, video demonstrations, video tutorials, or user manuals for software.

FIG. 3B illustrates an example process for generating recommendations and guidance for regulatory approval processes using the regulatory compliance analysis platform. In this example, the template 314 and content 316 are shown in a human-readable format. The user or product information may be input via a questionnaire 318 displayed on a computing device (e.g., user device 104). In the example shown in FIG. 3B, the user or product information include a logo for the company and a company name. As shown, the questionnaire fields may allow for product information to be provided via file upload or text input. In other examples, product information may further be provided through selection of options (e.g., through checkbox elements), audio input, and the like. The questionnaire fields are shown linked to a portion of the template 314 where the information will be inserted for content generation. For example, each field within the questionnaire 318 may be linked to a particular template characteristic. These fields are linked to the human-readable template via two blocks 320 and 322 of pseudo-code which represent the control portion of the template in this example. The pseudo-code in the example indicates that if the questionnaire fields are filled out then the information is included in the generated content, otherwise those spaces are left blank in the generated content. The human-readable, generated content 316 is shown connected to the human-readable template 314, with an example company logo and company name filled in to create the generated content. Generally, an example template with placeholders for the company logo and company name may be processed to create a content model with the placeholders replaced with information provided by the survey.

FIG. 3C illustrates an example of generating customized content using a template and questionnaire converted into customized content. The template 324 and content 326 are shown in a human-readable format. The questionnaire 328 in this example has two results both of which are yes/no questions: does the medical product contain software and does the medical product require sterilization. These questionnaire fields are shown linked to pseudo-code 330 and 332, which indicate how the responses to the questionnaire are used in processing the template. As shown in pseudo-code block 330, if a medical product does not include software, the entire document “SOP058 Product Software Development” does not need to be generated. Accordingly, no template would be loaded for that document to generate relevant content. However, if the answer for software inclusion is yes (e.g., the product does include software), then a template for the SOP058 document would be loaded and formatted to generate the document. Pseudo-code 332 shows that if a medical product does not require sterilization, then several SOP documents can be removed and text in the document “GOP001 Quality System Manual” should be updated. Template 324 shows the human-readable template for the GOP001 document, including sections 7.5.5 and 7.5.7, which should be updated when a product does not require sterilization, as shown in pseudo-code 332. The human-readable content 326 for the GOP001 document shows where the content has been replaced according to the instructions in the pseudo-code 332. In the example shown in FIG. 3C, should a product require sterilization, the GOP001 document would be generated including the text shown in the template 324, rather than being replaced in accordance with the pseudo-code 332.

FIG. 3D illustrates an example of generating customized content using a template and questionnaire converted into customized content. The template 338 and content 340 are shown in a human-readable format. The questionnaire 334 in this example accepts a list of responses. In some examples, the responses to the questionnaire 334 may be provided by text or voice input, selections from a drop down menu, and the like. The questionnaire 334 field is shown linked to pseudo-code 336 which provides instructions for incorporating the information from the questionnaire 334 into the template 338. In this case, for every item added in the questionnaire 334, a new entry is added to the table provided in the template 338. The content 340 includes the table of the template 338 with each row including answers provided through the questionnaire 334. In various examples, the content 340 may be inserted into another document, such as a SOP. The template 338 to generate the table may, in some examples, be referenced by another template for the SOP containing the table.

FIG. 4 illustrates a block diagram for maintaining and updating templates for use in generating customized content. Regulatory agencies, such as the FDA, continually revise the rules used to regulate medical products industries and products produced by medical products companies. Such updates are promulgated in a process external to an MPM. However, MPMs must be aware of such updates to remain compliant with various regulations. The regulatory compliance analysis platform 102 is configured to dynamically update the templates to adopt to the changing regulations. In some examples, the regulatory compliance analysis platform 102 may obtain such updates through user input, through scraping databases (e.g., public or private databases) including the relevant regulation. A process 408 updating the templates may receive the updated standards and regulations 412 and may survey the existing template database 402. The process 408 may assess how the templates in the template database 402 should be changed to bring the information in the templates back into a state of compliance with regulations. For example, the process 408 of the regulatory compliance analysis platform 102 may determine if components of the templates should be removed, new components of the templates should be added, or the templates should be otherwise updated to generate compliant content using the templates. Similarly, changes may be made to the survey and/or questionnaire to obtain the correct inputs for the updated templates.

Changes to templates or questionnaires may include, for example, updating the content of a template, creating new templates, removing unnecessary templates, updating the algorithms or software used to analyze the user input information in selecting a particular template, adding new survey questions, modifying existing survey questions, and/or removing existing survey questions. Changes to content within templates and survey questions may be done manually and template models may be generated automatically from existing documents or by manual entry. Updating content in a template manually may involve editing the text within the template model directly or updating a document which is used to automatically generate the template model.

The regulatory compliance and analysis platform 102 may automatically generate template models from documents using an algorithm to traverse a digital document in a standard format such as, for example, the Portable Document Format (PDF), text files, or word processor document. The algorithm may determine a hierarchy for content (e.g., by reading section numbering within the document, section breaks, and other logical break points), break apart content into smaller pieces (e.g., words, paragraphs, section headings) and creates model elements, and interconnect model elements according to the hierarchy traversed. For instance, a document with only a title and a single paragraph may be interpreted into a model with two model elements and a single connection between them where the first model element is the title, the second model element is the paragraph, and the connection between them indicates that the paragraph is contained under (e.g., held by) the title model element. Template models may require manual editing after this automated process. Control software may be identified by the software algorithm while traversing the document to create specific control elements if content within the document is formatted to represent control software (e.g., is written as code or uses special characters to indicate the start of control code).

Content within the templates may, in some examples, be modified manually by a quality professional or other expert who can determine the implications of the changes in regulatory information. For example, if regulations change to require more rigorous testing for software in medical products, a quality professional may rewrite content within the templates to indicate that medical products containing software must conform to this more rigorous testing. Controls in templates may be modified by software development professionals using information provided by a quality professional on the updated regulatory information. For example, if regulations change to require special considerations for software processing imaging data (e.g., from an MRI scan) an expert may determine that a question should be added to the survey to ask if the medical product processes imaging data. The survey may be updated to include the new question and the regulatory compliance analysis platform 102 may be updated to appropriately utilize answers to the newly added question. Control software embedded within the templates may be updated to determine how to utilize user answers to the newly added question to create custom content. Once updates have been made, the updated templates can be stored in the template database 402 from which data can be queried.

Templates may be computer files containing content and/or software instructions that may be used to process the information (e.g., information received through a questionnaire) into customized content. The template database 402 may include several types of templates, such as SOP templates 404, guidance templates 406, and action or deliverables 410. SOP templates 404 may be used to generate content contained in an SOP for a quality management system or forms and attachments for an SOP. Guidance templates 406 may be used to generate guidance documentation meant to provide instructions on how to use and/or implement SOPs. Action or deliverable templates 410 may be used to generate content including information on actionable tasks and deliverables that are required to be completed for regulatory compliance.

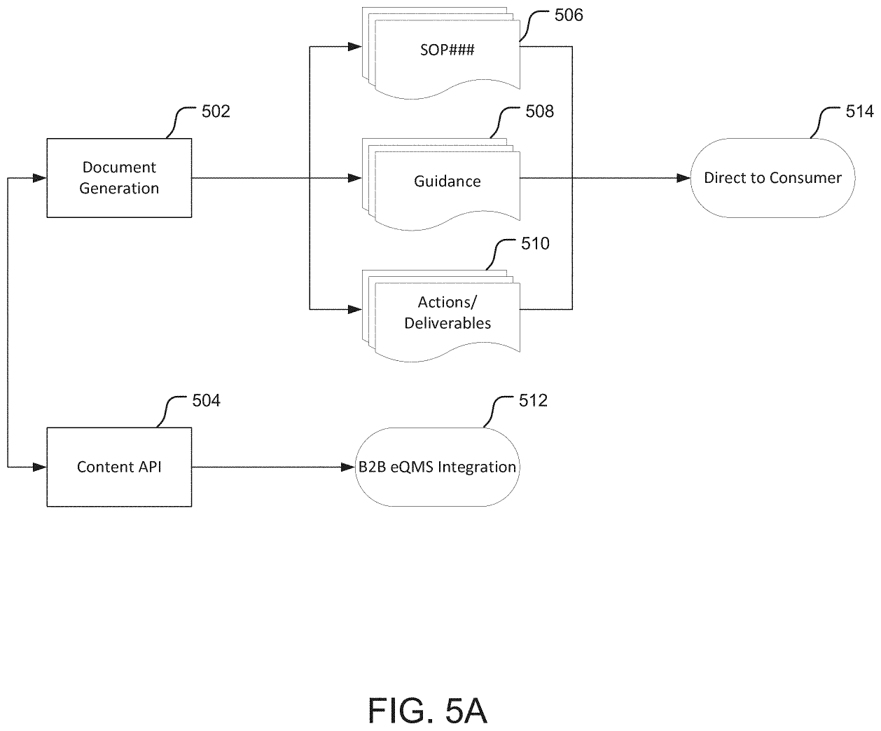

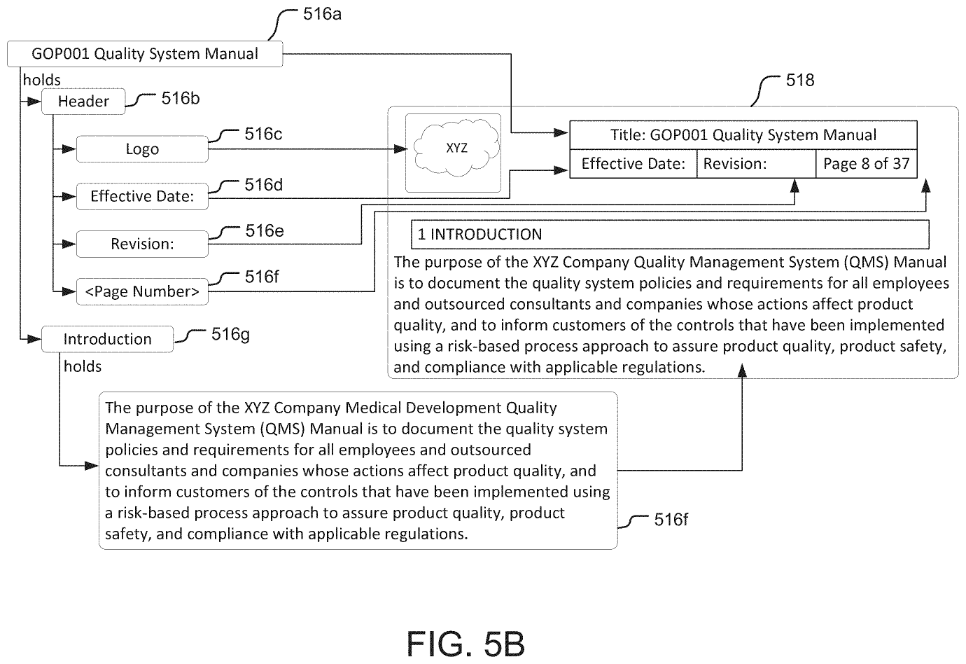

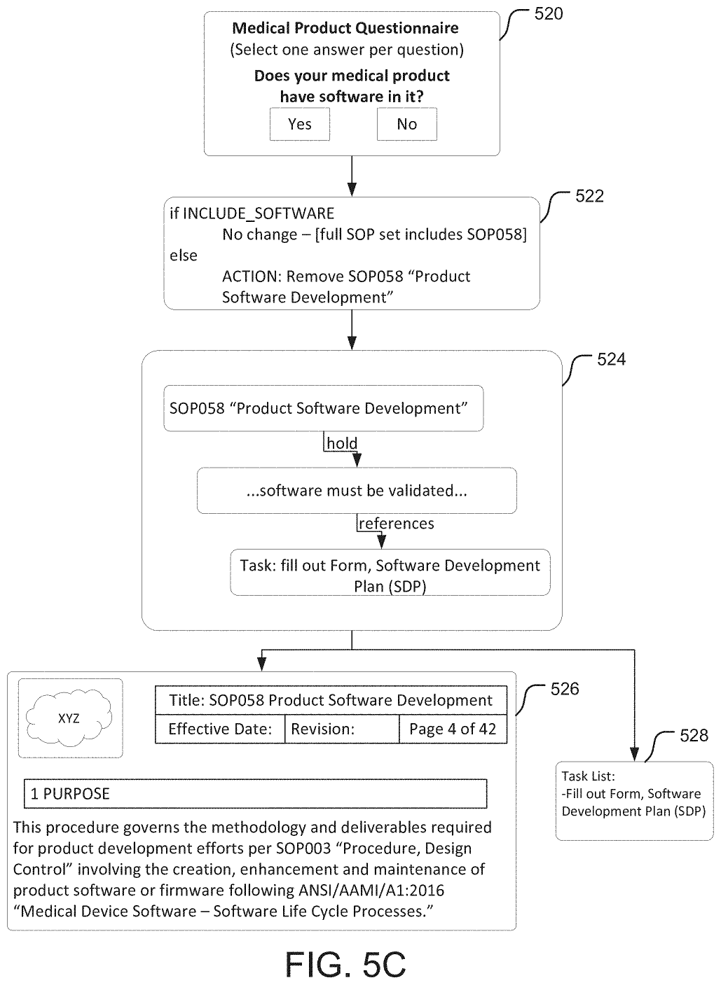

FIG. 5A illustrates a block diagram for utilizing output from the content database for both document generation and for delivering documents and customized content to end user. First, document generation 502 may form whole documents by merging content representing subcomponents of a document to form whole documents in a human-processable, well-known format such as (but not limited to) PDF, text files, or Microsoft Word documents. In various examples, content may be merged based on its overall structure. For example, document generation 502 may take individual content elements from a content model and systematically place them into an output document. The ordering and hierarchy of content within the content model may determine how the output document is constructed. For example, where the information is provided to an end user for display (e.g., through a user interface of the user device 104), the content model itself may be provided via an Application Programming Interface (API) (item 307). When streamed through an API, the content model may be delivered in a standardized format such as (but not limited to) JavaScript Object Notation (JSON) or Extensible Markup Language (XML). Documents generated by document generation 502 may include SOPs for a quality management system, forms and attachments for an SOP 506, guidance documentation 508 meant to provide instructions on how to use and/or implement SOPs, and/or or actionable tasks and deliverables 504 that are to be completed for regulatory compliance. These items may be delivered directly to an MPM or other user 514. Alternatively or additionally, content may be transmitted through a content API 504 to an external electronic system. The API in this case may translate the content from the internal format to a format that is processable by the external system 512. The external system may be an electronic Quality Management System (eQMS).

FIG. 5B shows an example content model processed into a human-readable document. In this example, the content model elements 516a-516h shown on the left are processed into the document 518 shown on the right. This process may use an artifact generation process whereby a computer application, such as a generator, traverses the model, following the connections between elements (shown here as arrows labeled “holds”). The generator may be programmed with instructions that allow it to take the data in the model elements and arrange them in a specific format. For example, the arrows from the model elements to the human-readable document show how content is placed into the document.

FIG. 5C illustrates an example of document and action list generation utilizing survey results and templates in accordance with embodiments described herein. A questionnaire 520 in includes a question asking whether software is involved in the medical product. Though the questionnaire 520 is shown as including one question, questionnaires utilized by the regulatory compliance analysis platform 102 may include more questions and different types of questions (e.g., free answer, selection from a drop down menu, and the like), in various examples. The template control logic 522 is shown as pseudo-code and indicates that where the device or product does include software, SOP058 is included in the full SOP set and, where the device or product does not include software, SOP058 is not included in the full SOP set, where SOP058 includes details of product software development. Where the survey 520 answer indicates that the product does have software, the regulatory compliance analysis platform 102 locates the appropriate template and utilizes a content model 524 associated with the template to generate a task list 528 associated with the SOP documentation 526. In some examples, the platform 102 may utilize control software to generate the content model 524 from the template and the questionnaire. For example, the content model 524 derived from the template and questionnaire shows that a part of the content of SOP058 indicates that software must be validated. The validation language then references a task indicating that a particular form (a software development plan) must be filled out. Accordingly, the platform 102 may generate the SOP documentation 526 using a template and at least the questionnaire responses and a task list 528 derived in part from the template, such as from the language of the SOP created by the template. In this way, a user is provided with not only the SOP documentation, but also with an additional task list to ensure that the product documentation is in compliance with relevant regulations.

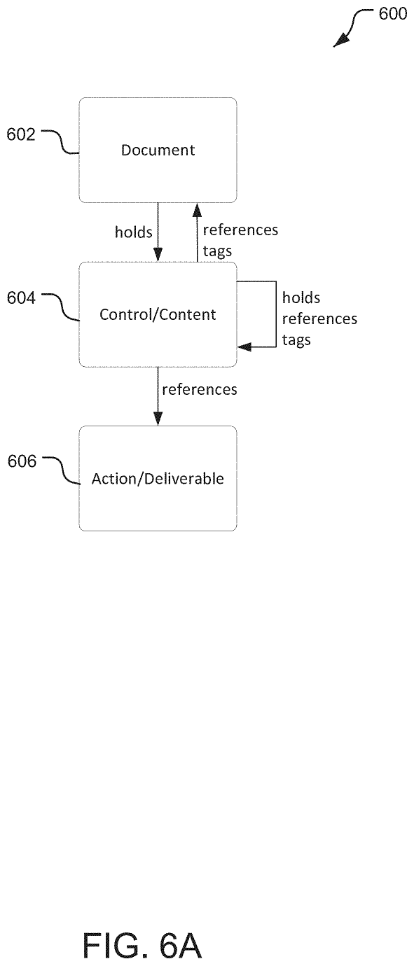

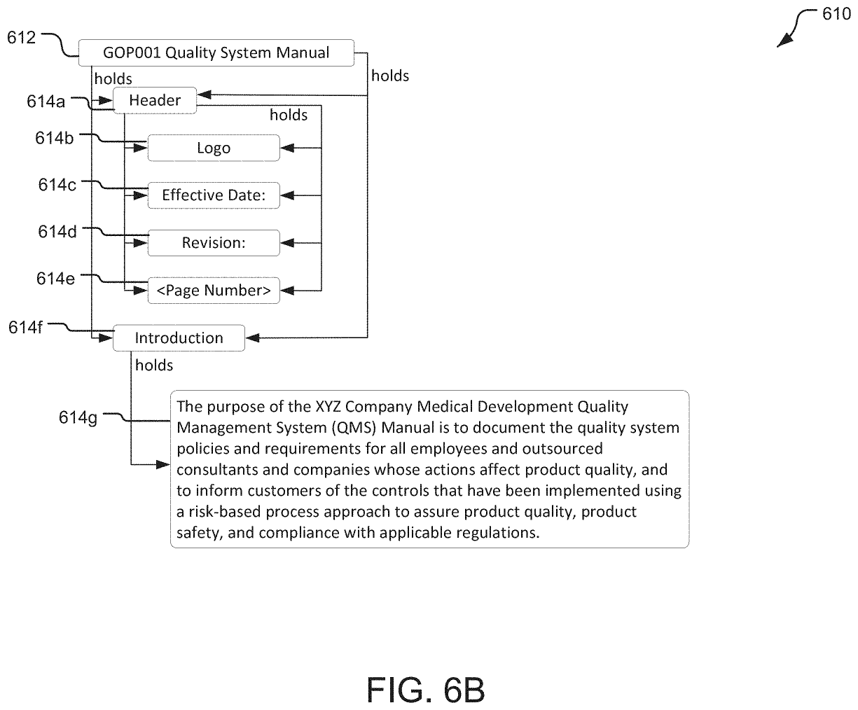

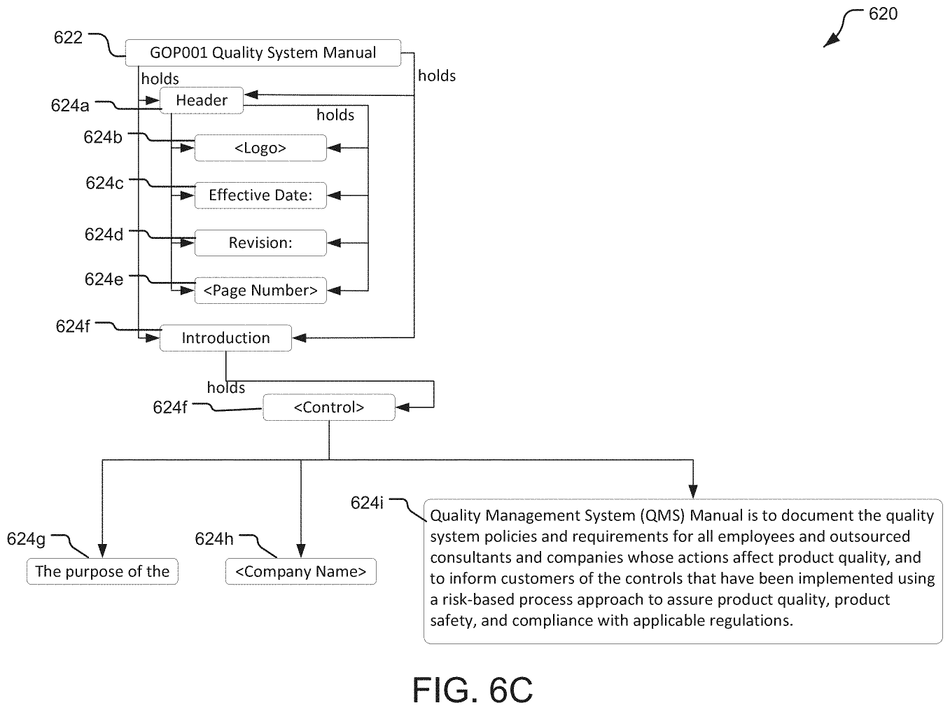

FIG. 6A illustrates the basic structure of a template model 600. The template model 600 includes a document element 602, a content control element 604, and an action deliverable element 606, which are each related to one another within the template to generate documentation. Content is generally grouped into one or more documents 602, where a document is a collection of content control elements 604 which may include text, metadata, formatting, figures, tables, software instructions, and other information. In some examples, content can be a control, meaning that the content provides software instructions to a content generation process and/or a document generation process (FIG. 5A). Generally, a document references content and content references or tags documents. For example, a document 602 may be stored in a database and may hold references to various content elements 604 which are included in the document. To create the document 602, the referenced content elements 604 may be pulled into the document. The separately stored content elements 604 may reference the documents utilizing the content, or the documents 602 and content 604 may be linked by the references in the document 602 without separate references in the content 604. Content 604 may also hold or reference other content and may therefore be organized into a hierarchical manner. For example, structure and/or framework of table (portions or the entirety thereof) may be a content element 604, and may hold or reference individual rows of the table (e.g., text to be inserted into individual rows of the table), which may also be content elements 604. Each of the content elements 604 may be stored individually in a content database and when the parent content element (e.g., a whole table) is pulled into a document, the child content elements (e.g., rows of the table) may be pulled into the parent content element using the references of the parent content element.

Content elements 604 may also reference actions and deliverables 606. Actions represent tasks which content is indicating must be completed while deliverables represent an item that is able to be provided as a product of a process (either as a digital item or a physical item). The relationship between content 604 and actions and deliverables 606 allows for task lists, guidance, and other deliverables to be generated with the SOP content. For example, with reference to FIG. 5C, the document “SOP058 Product Software development” references a content element with text stating the “software must be validated.” The content element then references a task to be completed as a result of the fact that the software must be validated to be in compliance with the relevant regulations. Accordingly, when the content is added to the document, the referenced task may also be added to an additional deliverable, such as an action list or other guidance document. In this way, the regulatory compliance analysis platform 102 may generate both SOP documentation and accompanying guidance and tasks to help product developers follow the SOP documentation quickly and accurately.

FIG. 6B provides an example of a content model 610. A document element 612 hold various content elements 614a-614g. That is, the document element 612 may be stored in one location (e.g., a database of various documents) with references to the content elements 614a-614g, which may be stored in other locations. As shown, content elements may also reference one another, such that when one content element is pulled into the document, additional content elements are also pulled in. In this way, the document element 612 may include references to larger content items (e.g., the header 614a and the introduction 614f), which are stored with references to other content items 614b-614e and 614g, respectively. Accordingly, the document element 612 includes references to fewer content elements and may be generated more quickly and efficiently than if the document element included separate references to each content element. The document element 612 may also utilize less storage space as a result of the reduced references to content elements 614a-614g. Some content elements, such as the page number 314e, may be control elements, which are filled in after content generation, rather than through survey answers or other methods of filling content elements. For example, page numbers may be added in once a document has been generated where page numbers are meaningful. While stored as a model of content, there is no indication on which page content will fall.

FIG. 6C provides an example of a template model 620, such as the template model used in FIG. 3B. A main document 622 may hold content. The template model 620 may generally include the document 622 and content 624a-624j held or referenced by the document 622. The content 614a-624i may include both content elements which are filled based on information collected or generated other than by a survey or reference to information about a product or company and control elements, which may reference particular pieces of product information. For example, text content element 624g and 624i may be static across documents. That is, the content elements 624g and 624i are pulled into a template for the main document 622 without pulling additional information from another source. Other elements, such as an effective date element 624c and a revision number 624d may pull answers directly from a survey, information from previous versions of the document 622, and the like. Control elements 624b, 624e, 624f, and 624h may include additional pseudo-code affecting how the content elements are ultimately rendered in the document 622. For example, a logo element 624b may be rendered as a company logo where one is uploaded via a questionnaire or other method. Where there is not logo available, the logo element 624b may be rendered as a blank box or may be left out of the document 622 entirely. As described with reference to FIG. 6B, the document 622 may include (e.g., be stored with) references to the high level content element 624a and 624f, and those content elements may be stored with reference to lower level content elements. In this manner the template model 620 for the document, and ultimately the document itself, may be efficiently stored and rendered.

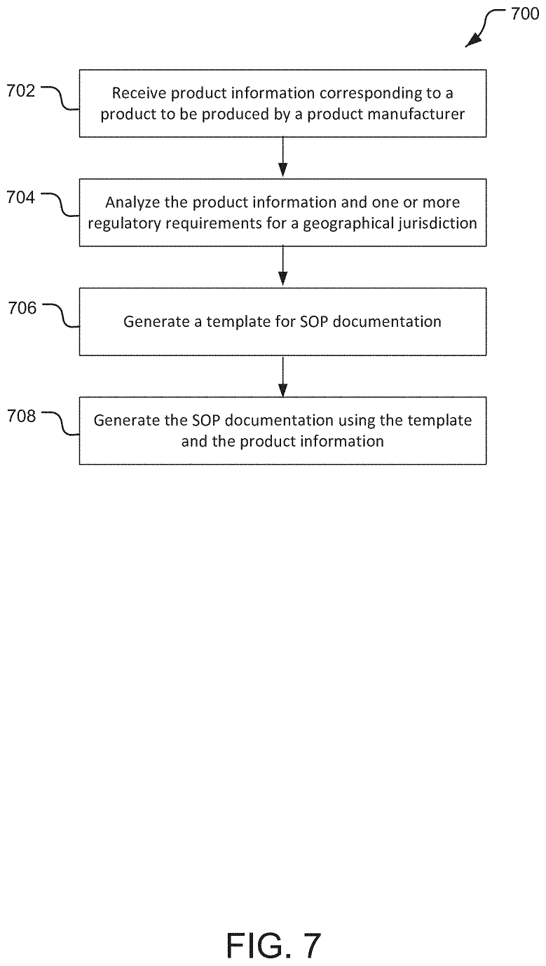

FIG. 7 illustrates a process 700 for generating SOP documentation in accordance with embodiments described herein. At block 702, the regulatory compliance analysis platform 102 receives product information corresponding to a product to be produced by a product manufacturer. Such information may be received, in various examples, as answers to a questionnaire presented via a user device 104, by searching public or private databases for information about a company, by referencing previous documentation created for the company, and the like. Such product information may include, for example, specifics of the product (e.g., whether the product contains software and whether the product is subject to specific guidelines such as sterilization), general information about the company (e.g., the name and a corresponding logo), and the like.

The platform 102 analyzes the product information and one or more regulatory requirements for a geographical jurisdiction at block 704. Such analysis may include a holistic review of the product information to determine which documents should be generated for a specific product. For example, a product including software may require additional SOP documentation not required for a product not including software. In various examples, the platform 102 may then locate document elements corresponding to the applicable documentation, which document elements may include references to content elements, and may be used to generate templates for the relevant documentation.

At block 706, the system 102 generates a template for the SOP documentation. The template may, in various examples, be generated by pulling in content elements referenced by a document element, additional content elements referenced by such content elements, and the like. The document elements may be stored with references to the content elements (e.g., storage locations or locations within a content database), such that the platform 102 may pull such content elements from their respective storage location to generate a template including all of the content elements. In various examples, the platform 102 may generate multiple templates based on the product information.

At block 708, the platform 102 generates the SOP documentation using the template and the product information. The content elements in a template may include instructions for pulling specific pieces of product information into the template, generating specific content for the documentation (e.g., page numbers, dates, and the like), and assembling and formatting such content into SOP documentation. In some examples, the content elements may include references to action items, guidance, or other information assisting the company in complying with the generated SOP. In such examples, guidance documentation, action item lists, and the like may be generated along with relevant SOP documentation.

In accordance with the above, a regulatory compliance analysis platform 102 may generate custom content, including SOPs and other regulatory documents, based on various information about a product and/or a company producing the product. The regulatory compliance and analysis platform 102 may utilize various templates to generate such content, and the templates may be updated to ensure that the custom content produced by the regulatory compliance analysis platform 102 is up to date with regulations. The templates may be stored as documents referencing individual content elements, where the content elements control how information is pulled into the template when rendering the document. Generally, this type of storage helps to reduce duplication, ultimately decreasing storage space used to store the templates, and improving efficiency of rendering documentation. Additionally, content elements may be stored with references to individual action items or other guidance content, which allows the regulatory compliance analysis platform 102 to generate meaningful action item lists and guidance along with SOP documents.

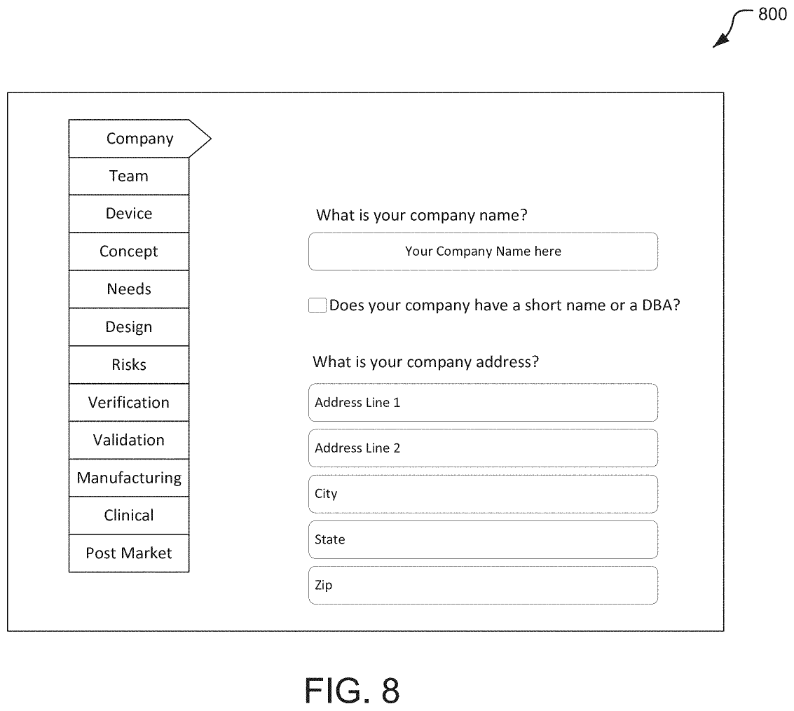

FIG. 8 illustrates an example user interface 800 displaying a questionnaire used in generating SOP documentation in accordance with embodiments described herein. The user interface 800 may be displayed, for example, at a display of a user device 104 accessing the regulatory compliance and analysis platform 102. As shown, the questionnaire may include questions and/or fields related to various aspects of a company and/or the product manufactured by the company. In various examples, answers provided via the user interface 800 may be used by the regulatory compliance analysis platform 102 to fill one or more templates to generate SOP documents and/or related guidance or other documentation.

The technology described herein may be implemented as logical operations and/or modules in one or more systems. The logical operations may be implemented as a sequence of processor-implemented steps executing in one or more computer systems and as interconnected machine or circuit modules within one or more computer systems. Likewise, the descriptions of various component modules may be provided in terms of operations executed or effected by the modules. The resulting implementation is a matter of choice, dependent on the performance requirements of the underlying system implementing the described technology. Accordingly, the logical operations making up the embodiments of the technology described herein are referred to variously as operations, steps, objects, or modules. Furthermore, it should be understood that logical operations may be performed in any order, unless explicitly claimed otherwise or a specific order is inherently necessitated by the claim language.

In some implementations, articles of manufacture are provided as computer program products that cause the instantiation of operations on a computer system to implement the procedural operations. One implementation of a computer program product provides a non-transitory computer program storage medium readable by a computer system and encoding a computer program. It should further be understood that the described technology may be employed in special purpose devices independent of a personal computer.

The above specification, examples and data provide a complete description of the structure and use of exemplary embodiments of the invention as defined in the claims. Although various embodiments of the claimed invention have been described above with a certain degree of particularity, or with reference to one or more individual embodiments, other embodiments using different combinations of elements and structures disclosed herein are contemplated, as other iterations can be determined through ordinary skill based upon the teachings of the present disclosure. It is intended that all matter contained in the above description and shown in the accompanying drawings shall be interpreted as illustrative only of particular embodiments and not limiting. Changes in detail or structure may be made without departing from the basic elements of the invention as defined in the following claims.

What is claimed is:

1. A method for generating standard operating procedure documentation comprising:
receiving by a processor product information corresponding to a product to be produced by a product manufacturer;
analyzing by the processor the product information and one or more regulatory requirements for a geographical jurisdiction;
generating by the processor a template for the standard operating procedure documentation, wherein the template includes a document element referencing multiple content elements within the template; and
generating by the processor the standard operating procedure documentation that defines operating procedures for testing, producing, manufacturing, and/or designing the product using the template and the product information.

2. The method of claim 1, further comprising generating by the processor at least one of an action item, a deliverable item, or a guidance item, based on the standard operating procedure content.

3. The method of claim 2, wherein the at least one of the action item, the deliverable item, or the guidance item are generated using the content elements of the template, wherein the content elements of the template include at least one reference to elements to be included in the action item, the deliverable item, or the guidance item.

4. The method of claim 1, wherein the template is selected from a plurality of templates, wherein the plurality of templates are dynamically varied based on changes to the one or more regulatory requirements.

5. The method of claim 1, wherein receiving by the processor the product information comprises:
transmitting an input form to a user device; and
receiving data input into the input form from the user device.

6. The method of claim 1, further comprising transmitting the standard operating procedure content to a user device associated with the product manufacturer.

7. A regulatory and compliance platform comprising:
a template database comprising a plurality of regulatory compliance templates, wherein the regulatory compliance templates are specific to a product type, a product operation, and/or a product jurisdiction; and
a processor executing an analysis algorithm in communication with the template database, wherein the analysis algorithm is configured to:
receive product information for a product to be produced by a product manufacturer;
analyze the product information to select and generate a regulatory compliance template from the plurality of regulatory compliance templates, wherein the regulatory compliance template includes a document element referencing multiple content elements within the regulatory compliance template;
populate, based on the multiple content elements, the regulatory compliance template with information specific to the product and the product manufacturer; and
generate one or more of a standard operating procedures content, a deliverable item, an action item, or a guidance content based on the populated regulatory compliance template.

8. The system of claim 7, wherein the plurality of regulatory compliance templates are dynamically updated to align with changes to regulatory requirements.

9. The system of claim 7, wherein the analysis algorithm is further configured to generate a standard operating procedures content and an action item, wherein the action item is generated based on a reference to the action item by at least one of multiple content elements of the regulatory compliance template corresponding to the standard operating procedures content.

10. The system of claim 7, wherein at least one of the multiple content elements references another content element.

11. The system of claim 7, wherein the analysis algorithm is further configured to:
transmit an input form to a user device; and
receiving the product information as data input into the input form from the user device.

12. The system of claim 7, wherein the analysis algorithm is further configured to transmit the one or more of the standard operating procedures content, the deliverable item, the action item, or the guidance content to a user device associated with the product manufacturer.

13. The system of claim 7, wherein the analysis algorithm is further configured to generate the standard operating procedures content and one of the deliverable item, the action item, or the guidance content, wherein the deliverable item, the action item, or the guidance content is based on information in the standard operating procedures content.

14. One or more non-transitory computer readable media encoding instructions which, when executed by one or more processors, cause the one or more processors to:
receive product information corresponding to a product to be produced by a product manufacturer;
analyze the product information and one or more regulatory requirements for a geographical jurisdiction;
generate a template for the standard operating procedure documentation, wherein the template includes a document element referencing multiple content elements within the template; and
generate the standard operating procedure documentation that defines operating procedures for testing, producing, manufacturing, and/or designing the product using the template and the product information.

15. The one or more non-transitory computer readable media of claim 14, wherein the instructions further cause the one or more processors to generate at least one of an action item, a deliverable item, or a guidance item, based on the standard operating procedure content.

16. The one or more non-transitory computer readable media of claim 15, wherein the at least one action item, the deliverable item, or the guidance item are generated using the content elements of the template, wherein the content elements of the template include at least one reference to elements to be included in the action item, the deliverable item, or the guidance item.

17. The one or more non-transitory computer readable media of claim 16, wherein the template is selected from a plurality of templates, wherein the plurality of templates are dynamically varied based on changes to the one or more regulatory requirements.

18. The one or more non-transitory computer readable media of claim 14, wherein the one or more processor receive the product information by transmitting an input form to a user device and receiving data input into the input form from the user device.

19. The one or more non-transitory computer readable media of claim 14, wherein the instructions further cause the one or more processors to transmit the standard operating procedure content to a user device associated with the product manufacturer.

20. The one or more non-transitory computer readable media of claim 14, wherein at least one of the multiple content elements within the template references an additional content element.
